(19) United States
(12) Patent Application Publication
(10) Pub. No.: US 2004/0182349 A1
(43) Pub. Date: Sep. 23, 2004

(54) Intake manifold and method of manufacturing such manifold

(76) Inventor: Morten August Herbert Kuhlen, Moenchengladbach (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/765,363

(22) Filed: Jan. 27, 2004

Related U.S. Application Data
(62) Division of application No. 10/262,094, filed on Oct. 1, 2002.

(30) Foreign Application Priority Data
Oct. 8, 2001 (EP) 01123962.1

(51) Int. Cl. F02M 35/10

(52) U.S. Cl. 123/184.61

(57) ABSTRACT

A single piece intake manifold having a core and a seal. Material of the seal and material of the core are intermixed to bond the core to the seal. The core is a plastic material such as a polyamide and/or a thermoplastic material. The seal is rubber, plastic or a thermoplastic elastomer. A method for manufacture the intake manifold includes providing a two-piece casting mold, one piece having walls configured to receive a liquefied core material and another piece having walls configured to receive a liquefied seal material. The liquefied seal material is introduced into the mold, and, separately therefrom, the liquefied core material is introduced into the casting mold. When the seal material and the core material are combined in the casting mold, they are both unhardened, or at least partially un-hardened. Heat is applied to the core material and the seal material after such materials are introduced into the mold. Intake manifold made of plastic and method for manufacturing it.

### FIELD OF THE INVENTION

This invention relates to an intake manifolds and to methods for manufacturing such an intake manifolds.

### BACKGROUND OF THE INVENTION

As is known in the art, intake manifolds are used in internal combustion engines to feed combustion air to the engine cylinders. Known intake manifolds are predominantly manufactured from thermoplastics and connected to the cylinder head of the engine or to other devices of the motor vehicle using integrally formed-on flanges. In order to seal the connections between the intake manifold and the cylinder head, rubber seals are generally provided on flanges of the intake manifold. Such rubber seals must be manufactured separately and used individually for mounting the intake manifold to the cylinder head. This is, on the one hand, very time consuming. Further, unsatisfactorily applied seals or seals lead to replacement of such seals.

A method for manufacturing a thermoplastic component with a seal which is injection molded into place is described in WO 00/23241. Here, a groove with upright edges is provided for receiving the seal. After the thermoplastic component solidifies, a seal made of a different material from the component, is injection molded into the groove. The edges of the groove prevent excessive injection molding. Finally, the edges of the groove are shaped or pressed in order to retain the seal in the groove.

A similar method is described in U.S. Pat. No. 5,246,065. Here the method introduces an elastomer seal into the groove of a thermoplastic component. A projection protrudes from the component being shaped after the insertion of the seal in order to retain the seal in the component.

Against the background, an object of the present invention was to provide an intake manifold and method for manufacturing which ensure simple amount and greater operational reliability.

### SUMMARY OF THE INVENTION

This and other objects of the invention are achieved by providing a single piece intake manifold. The intake manifold has a core and a seal. Material of the seal and material of the core are intermixed to bond the core to the seal.

In one embodiment, the core has a flange portion and wherein the seal bonded to the flange portion.

In one embodiment, the core is a plastic material.

In one embodiment, the core material of the intake manifold is polyamide and/or a thermoplastic material.

In one embodiment, the core is a material mutually linked to material of the seal.

In accordance with another feature of the invention, a method is provided for manufacturing an intake manifold. The method includes providing a two-piece casting mold, one piece having walls configured to receive a liquefied core material and another piece having walls configured to receive a liquefied seal material. The liquefied seal material is introduced into the mold, and, separately therefrom, the liquefied core material is introduced into the casting mold.

In one embodiment, when the seal material and the core material are combined in the casting mold, they are both unhardened, or at least partially unhardened.

In one embodiment, heat is applied to the core material and the seal material after such materials are introduced into the mold.

In one embodiment, the materials comprises filling the casting mold are introduced under process conditions wherein the materials intermix.

The intake manifold according to the invention, made of plastic, is defined in that it contains sealing regions which are provided for producing a closed connection to other components, the sealing regions being composed of a soft, elastic material and being connected to the core material of the intake manifold by a materially linked connection.

In contrast to known intake manifolds, there are therefore no separate seals provided for sealing the connections of the intake manifold to other components. Instead, sealing regions, which are composed of a soft and flexible material and can thus perform a sealing function similar to the separate seals, are formed integrally with the intake manifold. These sealing regions are connected to the intake manifold by means of a materially linked connection or a positively locking connection. The integral formation of the intake manifold with the seals has the advantage that when the intake manifold is mounted there is no need to install separate sealing rings or the like, as a result of which a very time-consuming and laborious processing step is dispensed with. In addition, it is ensured that during the mounting the seals always come to rest at the correct location and can thus perform their sealing function to an optimum degree. The sealing regions are preferably provided here on flanges of the intake manifold, which serve to connect the intake manifold to other components. In particular, a sealing region may be provided on the flange of the intake manifold via which the latter is connected to the cylinder head of an internal combustion engine.

The sealing regions may be preferably composed of rubber, of a suitable plastic or of a thermoplastic elastomer (TPE).

The core material of the intake manifold of which it is mainly or completely composed can be, in particular, the plastics polyamide 6 (PA6), polyamide 66 (PA66) and/or some other suitable thermoplastic. Such plastics have proven particularly suitable for manufacturing intake manifolds.

The invention also relates to a method for manufacturing a plastic intake manifold of the type mentioned above. In this method, the liquefied material of the later sealing regions is introduced into a casting mold at the points which are provided for the seals. Separately from this, the liquefied core material of the intake manifold is generally previously introduced into the same casting mold. The two materials are preferably injected into the casting mold in such a close chronological succession that they are both still liquid or soft at the same time. That is to say the second component is filled into the casting mold while the first component is not yet completely hardened. Moreover, partial cross-linking of the first component is permissible. It is important for the process heat for both component parts to be utilized. As a result of the contact in the not yet completely hardened state, a particularly intimate connection, in particular partial intermixing and/or mutual diffusion may occur at the contact points of the materials, which ensures a materially linked connection and/or positively locked connection between the materials. In particular rubber or thermoplastic elastomers, which are relatively soft and elastic in the solidified state, are suitable as materials for the sealing regions.

According to a second variant of a manufacturing method for an intake manifold of the type mentioned above, a casting mold for the intake manifold including the sealing regions is filled with a liquefied material, the sealing regions within the casting mold being filled under process conditions which favor the generation of a soft, flexible, elastic material in the hardened state. The other regions of the casting mold which correspond to the core body of the intake manifold are, on the other hand, filled under process conditions which give rise to a relatively solid, rigid state of the material. In this method, the manufacture of the intake manifold is particularly simple as it is not necessary to change materials when filling the casting mold. All that is necessary is to vary the process conditions, for example, the temperature of the material filled in, the pressure of the material filled in, the occlusion of air or gases, the sealing of the material filled in and the like.

### DESCRIPTION OF THE DRAWINGS

The invention is explained by way of example below using the Figures, in which:

FIG. 1 shows the assembly of a casting mold for an intake manifold according to the invention.

FIG. 2 shows the manufacture of the core regions in the assembled casting mold according to FIG. 1;

FIG. 3 shows the manufacture of the sealing regions in the casting mold from FIG. 2.

Like reference symbols in the various drawings indicate like elements.

### DETAILED DESCRIPTION

Referring now to the Figures, it is first noted that the Figures are schematic representations of the process steps during the manufacture of an intake manifold according to the invention. Here, of the intake manifold itself, only a tubular connecting piece 7 with attachment flanges 8 and an integrated sealing ring 5, are illustrated in cross section in a representative fashion.

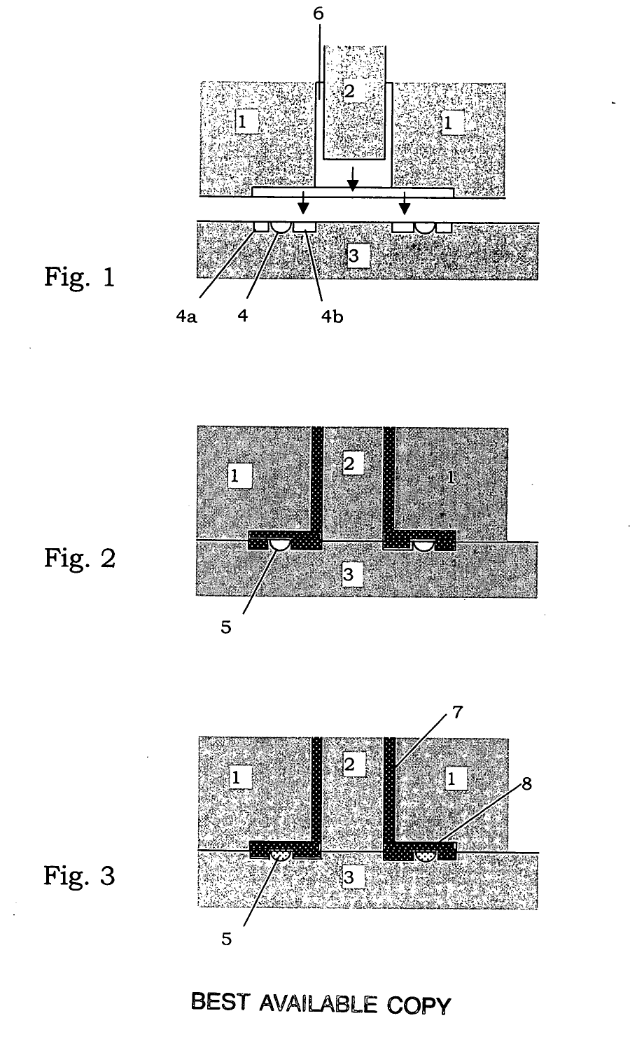

FIG. 1 shows a cross section through a casting mold in an exploded view or during its assembly. The casting mold is composed of a base 3 onto which an upper part 1 with a cylindrical cutout is fitted. A cylindrical die 2 is fitted into the aforesaid cutout, the external diameter of which die is smaller than the internal diameter of the cylindrical cutout in the upper part 1. In this way an annular gap 6 is produced between the die 2 and the cutout in the upper part 1.

The upper part 1 also has, on its side facing the base 3, a broad annular depression, which is continuous with the cylindrical cutout. This annular depression provides the space for a flange 8, which surrounds the connecting piece 7, which is produced in the annular gap 6.

In addition, the groove 4, which runs around in a circular shape concentrically with respect to the axis of the connecting piece and whose radius is selected such that it runs in the internal region of the flange 8, is formed in the base 3. This groove 4 constitutes a sealing region, that is to say, a space which is later taken up by a seal 5 on the finished intake manifold. The two grooves 4a, 4b, which additionally run round in a circular shape, are also filled with flange material. They are flatter than the groove 4 provided for the seal so that while the intake manifold is installed in accordance with regulations a defined pre-stress is exerted on the seal 5, and in particular the seal is not pressed, which can in turn lead to functional errors as a result of flowing of the seal which possibly occurs then.

Referring to FIG. 2, the casting mold is illustrated in the assembled state of base 3, upper part 1 and die 2. In addition, it is apparent in FIG. 2 that the core material 7 of the intake manifold has already been injection molded into the casting mold. This core material then fills the annular gap 6 and the flange regions 8 and forms the actual body of the intake manifold.

Before the core material 7 which is filled in according to FIG. 2 is completely hardened or cross-linked, the sealing material 5 is injection molded into the casting mold according to FIG. 3. This may be, in particular, TPE. As, during the injection molding of the sealing material 5, the core material is not yet completely cross-linked and partially still fluid, an intimate connection and a materially linked connection are formed between the material of the sealing regions 5 and the core material 7. The finished intake manifold, which is obtained after the casting mold is opened (not illustrated), thus has integrally formed-on seals 5, which permits considerably simplified mounting of the intake manifold into an engine.

A number of embodiments of the invention have been described. Nevertheless, it will be understood that various modifications may be made without departing from the spirit and scope of the invention. Accordingly, other embodiments are within the scope of the following claims.

What is claimed is:

1. In intake manifold comprising:
a plastic core; and
a sealing region for producing a closed connection to another component, such sealing region being a soft, elastic material and being connected to the plastic core by a materially linked connection and/or by means of a positively locking connection.

2. The intake manifold as claimed in claim 1, wherein the sealing regions are composed of rubber, of plastic, or of a thermoplastic elastomer.

3. The intake manifold as claimed in claim 1 wherein the core material of the intake manifold is PA6 material, PA66 material and/or a thermoplastic material.

4. The intake manifold as claimed in claim 2 wherein the core material of the intake manifold is PA6 material, PA66 material and/or a thermoplastic material.

5. A method for manufacturing an intake manifold, comprising:
introducing a liquefied material of the sealing regions, and, separately therefrom, a liquefied core material of the intake manifold core into a casting mold.

6. The method as claimed in claim 5, wherein, when the material of the sealing regions and the core material are combined in the casting mold, they are both unhardened, or at least partially un-hardened.

7. The method recited in claim 5 comprising:
filling the casting mold with the liquefied materials, and
wherein the sealing regions within the casting mold are filled under process conditions which favor the generation of an elastic material which is soft in the solidified state.

8. The method recited in claims 6 comprising:
filling the casting mold with the liquefied materials, and
wherein the sealing regions within the casting mold are filled under process conditions which favor the generation of an elastic material which is soft in the solidified state.

9. An intake manifold, comprising:
a core;
a seal; and
wherein material of the seal and material of the core are bond one to the other to provide a single piece structure, such structure having the core and the seal.

10. The intake manifold recited in claim 9 wherein material providing the core and material providing the seal are intermixed one with the other.

11. The intake manifold as claimed in claim 10, wherein the core has a flange portion and wherein the seal bonded to the flange portion.

12. The intake manifold as claimed in claim 10 wherein the core is a plastic material.

13. The intake manifold recited in claim 10 wherein the core material of the intake manifold is polyamide and/or a thermoplastic material.

14. The intake manifold recited in claim 10 wherein the core is a material mutually linked to material of the seal.

15. A method for manufacturing an intake manifold, comprising:
providing a two-piece casting mold, one piece having walls configured to receive a liquefied core material and another piece having walls configured to receive a liquefied seal material; and
introducing the liquefied seal material into the mold, and, separately therefrom, introducing the liquefied core material of the into the casting mold.

16. The method as claimed in claim 15, wherein, when the seal material and the core material are combined in the casting mold, they are both unhardened, or at least partially unhardened.

17. The method recited in claim 16 including applying heat to the core material and the seal material after such materials are introduced into the mold.

18. The method recited in claim 15 wherein introducing the materials comprises filling the casting mold under process conditions wherein the materials intermix.

19. The method recited in claim 18 including applying heat to the core material and the seal material after such materials intermix.
